(19) United States
(12) Patent Application Publication
(10) Pub. No.: US 2026/0178700 A1
(43) Pub. Date: Jun. 25, 2026

(54) INFORMATION PROCESSING DEVICE AND INFORMATION PROCESSING METHOD

(71) Applicant: NEC Corporation, Minato-ku, Tokyo (JP)

(72) Inventors: Keisuke Suzuki, Tokyo (JP); Masanori Tsujikawa, Tokyo (JP)

(73) Assignee: NEC Corporation, Minato-ku, Tokyo (JP)

(21) Appl. No.: 18/727,191

(22) PCT Filed: Jan. 18, 2022
(86) PCT No.: PCT/JP2022/001574

§ 371 Date: Jul. 8, 2024

(51) Int. Cl. G06F 17/18; G06F 17/17

(52) U.S. Cl. CPC G06F 17/18; G06F 17/17

(57) ABSTRACT

The information processing device 10 includes a normal approximation unit which performs an approximation process to approximate estimate distribution with normal distribution, a deviation evaluation unit which evaluates a deviation that occurs in the approximation process, and a data evaluation unit which evaluates data related to the calculation of the estimate from a result of the approximation process and the deviation.

### TECHNICAL FIELD

This invention relates to an information processing device and an information processing method.

### BACKGROUND ART

An example of a sample size determination method is described in Non-patent Literature 1. In that method, for a specified error ε₁, ε₂ (>0), reliability (degree of reliability) 1−δ, and variance σ², it is assumed that the finite samples x₁, . . . , xₙ arise from a normal distribution with average μ and variance σ². The method then determines the sample size n required to satisfy the inequality expressed in equation (2) with probability that the sample average expressed in equation (1) is greater than or equal to 1−δ to be the smallest natural number greater than or equal to the value expressed in equation (3). z_{δ/2} is the upper δ/2 point of the standard normal distribution. min{ε₁, ε₂} is the minimum value of ε₁, ε₂.

$$\begin{matrix}[ Math . 1 ] & \\ \overline{{x}_{n}} = \frac{1}{n} {\sum }_{i = 1}^{n} {x}_{i} & ( 1 )\end{matrix}$$

$$- {ε}_{1} ≦ \overline{{x}_{n}} - μ ≦ {ε}_{2} \qquad ( 2 )$$

$$\frac{{z}_{δ / 2}^{2} {σ}^{2}}{min {\{ {ϵ}_{1} , {ε}_{2} \}}^{2}} \qquad ( 3 )$$

### CITATION LIST

### Non Patent Literature

NPL 1: Yasushi Nagata, “How to Determine Sample Size,” Asakura Shoten, Sep. 20, 2003, pp. 182-183

### SUMMARY OF INVENTION

### Technical Problem

The scope of application of the sample size determination method described in Non-patent Literature 1 is limited to normal distribution only. The reason is that the distribution of estimates cannot be attributed to a known distribution with sample size n as a parameter when properties inherent to a normal distribution, such as reproducibility, cannot be assumed.

It is an object of the present invention to provide an information processing device and an information processing method that can perform sample size determination, etc. even when normality cannot be assumed.

### Solution to Problem

The information processing device of an aspect of the present invention includes normal approximation means for performing an approximation process to approximate estimate distribution with normal distribution, deviation evaluation means for performing a deviation evaluation process that evaluates a deviation that occurs in the approximation process, and data evaluation means for evaluating data related to calculation of an estimate from a result of the approximation process and the deviation.

The information processing method of an aspect of the present invention includes performing a approximation process to approximate estimate distribution with normal distribution, evaluating a deviation that occurs in the approximation process, and evaluating data related to calculation of the estimate from a result of the approximation process and the deviation.

The information processing program of an aspect of the present invention causes a computer to execute performing a approximation process to approximate estimate distribution with normal distribution, evaluating a deviation that occurs in the approximation process; and evaluating data related to calculation of the estimate from a result of the approximation process and the deviation.

### Advantageous Effects of Invention

According to the present invention, it is possible to perform sample size determination, etc. necessary for the calculation of estimates for general distribution that is not limited to the normal distribution. The reason for this is that the distribution of the estimates can be evaluated without using property inherent to the normal distribution through normal approximation and deviation evaluation.

### BRIEF DESCRIPTION OF DRAWINGS

FIG. 1 It depicts a block diagram showing a configuration example of a sample size determination device.

FIG. 2 It depicts a flowchart showing an operation of the sample size determination device.

FIG. 3 It depicts a block diagram showing a configuration example of reliability determination device.

FIG. 4 It depicts a flowchart showing an operation of the reliability determination device.

FIG. 5 It depicts a block diagram showing a configuration example of an error determination device.

FIG. 6 It depicts a flowchart showing an operation of the error determination device.

FIG. 7 It depicts a block diagram showing first example.

FIG. 8 It depicts a block diagram showing second example.

FIG. 9 It depicts a block diagram showing third example.

FIG. 10 It depicts a block diagram showing fourth example.

FIG. 11 It depicts a block diagram showing fifth example.

FIG. 12 It depicts a block diagram showing an example of a computer with a CPU.

FIG. 13 It depicts a block diagram showing the main part of the information processing device.

### DESCRIPTION OF EMBODIMENTS

Hereinafter, an example embodiment of the present invention will be explained with reference to the drawings.

### Example Embodiment 1

### [Description of Configuration]

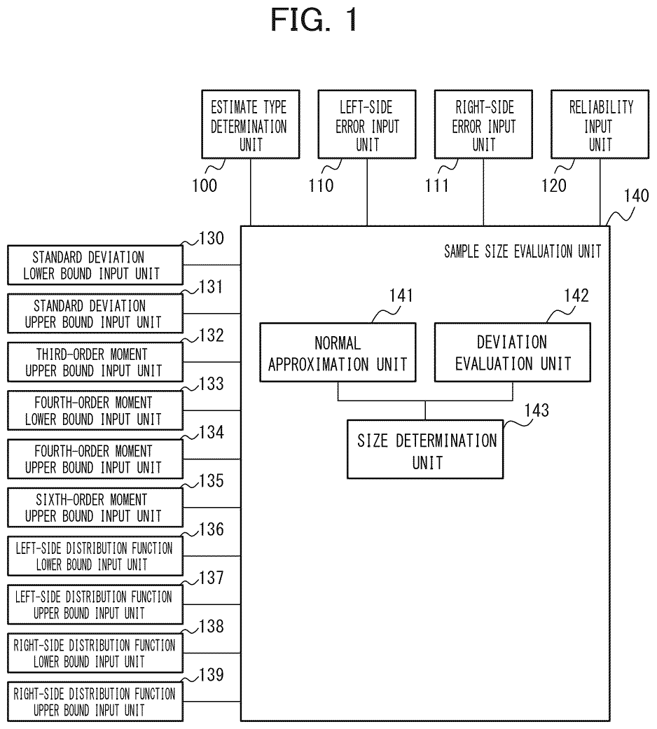

FIG. 1 is a block diagram showing a configuration example of a sample size determination device as the first example embodiment of an information processing device. As shown in FIG. 1, the sample size determination device comprises an estimate type determination unit 100, a left-side error input unit 110, a right-side error input unit 111, a reliability input unit 120, a standard deviation lower bound input unit 130, a standard deviation upper bound input unit 131, a third-order moment upper bound input unit 132, a fourth-order moment lower bound input unit 133, a fourth-order moment upper bound input unit 134, a sixth-order moment upper bound input unit 135, a left-side distribution function lower bound input unit 136, a left-side distribution function upper bound input unit 137, a right-side distribution function lower bound input unit 138, a right-side distribution function upper bound input unit 139, and a sample size evaluation unit 140.

The left-side error input unit 110, the right-side error input unit 111, the reliability input unit 120, the standard deviation lower bound input unit 130, the standard deviation upper bound input unit 131, the third-order moment upper bound input unit 132, the fourth-order moment lower bound input unit 133, the fourth-order moment upper bound input unit 134, the sixth-order moment upper bound input unit 135, the left-side distribution function lower bound input unit 136, the left-side distribution function upper bound input unit 137, the right-side distribution function lower bound input unit 138, and the right-side distribution function upper bound input unit 139 input left-side error, right-side error, reliability, standard deviation lower bound, standard deviation upper bound, third-order moment upper bound, fourth-order moment lower bound, fourth-order moment upper bound, sixth-order moment upper bound, left-side distribution function lower bound, left-side distribution function upper bound, right-side distribution function lower bound, and right-side distribution function upper bound, respectively.

The estimate type determination unit 100 determines an input type of estimate. That is, the estimate type determination unit 100 determines a type of estimate to be calculated. The type of estimate is a sample average, an unbiased variance, or a sample quantile. Therefore, data that can identify the sample average, unbiased variance, or sample quantile is input to the estimate type determination unit 100.

The sample size evaluation unit 140 includes a normal approximation unit 141, a deviation evaluation unit 142, and a size determination unit 143.

Assuming the case where an estimate of the input type is calculated from a sample with a fixed sample size, for the fixed sample size, the normal approximation unit 141 calculates a value (hereinafter, sometimes referred to as “asymptotic approximation probability”) that approximates a probability, by asymptotic normality of estimate distribution, that the value obtained by subtracting the estimate from the true value, which is the value to be estimated, is less than or equal to the left-side error and the value obtained by subtracting the true value from the estimate is less than or equal to the right-side error. In other words, the normal approximation unit 141 performs an approximation process to approximate the estimate distribution with a normal distribution. The estimate distribution is the probability distribution that the estimate follows.

The deviation evaluation unit 142 evaluates deviation generated by the approximation process by the normal approximation unit 141. Specifically, assuming the case where an estimate of the input type is calculated from a sample with a fixed sample size, for a fixed sample size, the deviation evaluation unit 142 calculates the upper bound of absolute values for the difference (hereinafter, sometimes referred to as “deviation”) between the probability that the value obtained by subtracting the estimate from the true value is less than or equal to the value of the left-side error and the value obtained by subtracting the true value from the estimate is less than or equal to the value of the right-side error, and the value obtained by approximating the probability by asymptotic normality of the estimate distribution.

The size determination unit 143 evaluates data related to the calculation of the estimate based on the result of the approximation process by the normal approximation unit 141, i.e., the asymptotic approximation probability and the deviation by the deviation evaluation unit 142. For example, the size determination unit 143 sets the initial value of sample size n to 2 and repeats the following procedure until a sample size that satisfies the predetermined conditions is determined. Specifically, for a sample size n, the size determination unit 143 subtracts the value calculated by the deviation evaluation unit 142 from the value calculated by the normal approximation unit 141, and when this value is greater than or equal to the reliability, the size determination unit 143 determines the sample size required to calculate the estimate to be n at that time. When this is not the case, the size determination unit 143 updates the sample size to n+1.

### [Description of Operation.]

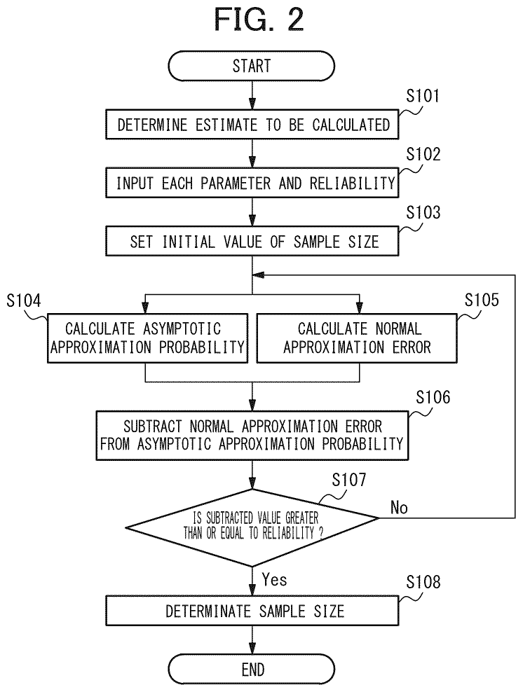

Next, the operation of the sample size determination device of this example embodiment is explained with reference to the flowchart of FIG. 2.

First, the estimate type determination unit 100 determines the type of input calculated estimate (estimate to be calculated) (step S101).

The sample size evaluation unit 140 inputs each parameter (step S102). In this example embodiment, in the process of step S102, the sample size evaluation unit 140 inputs the left-side error ε₁ and the right-side error ε₂ through the left-side error input unit 110 and the right-side error input unit 111. The sample size evaluation unit 140 also inputs the standard deviation lower bound σ₁, the standard deviation upper bound σ₂, the third-order moment upper bound A, the fourth-order moment lower bound B, the fourth-order moment upper bound C, the sixth-order moment upper bound D, the left-side distribution function lower bound l₁, the left-side distribution function upper bound u₁, the right-side distribution function lower bound l₂, the right-side distribution function upper bound u₂ through the standard deviation lower bound input unit 130, the standard deviation upper bound input unit 131, the third-order moment upper bound input unit 132, the fourth-order moment lower bound input unit 133, the fourth-order moment upper bound input unit 134, the sixth-order moment upper bound input unit 135, the left-side distribution function lower bound input unit 136, the left-side distribution function upper bound input unit 137, the right-side distribution function lower bound input unit 138, and the right-side distribution function upper bound input unit 139.

Each parameter is set to satisfy the following condition. That is, for a random number X that follows a distribution that generates independent and identically distributed finite samples used to calculate the estimate, the following condition is satisfied when the expected value is expressed as μ=E[X], the standard deviation as σ (refer to equation (4)), the cumulative distribution function as F, and the 100p % point of F as εₚ=inf{t|F(t)≥p}. It should be noted that 0<p<1.

$$\begin{matrix}[ Math . 2 ] & \\ σ = \sqrt{E [ {( X - μ )}^{2} ]} & ( 4 )\end{matrix}$$

$${σ}_{1} \leq σ \leq {σ}_{2} \qquad ( 5 )$$

$$E [ \vert ( X - μ ) {\vert}^{3} ] \leq A \qquad ( 6 )$$

$$B \leq E [ \vert {( X - μ )}^{2} - {0}^{2} {\vert}^{2} ] \leq C \qquad ( 7 )$$

$$E [ \vert {( X - μ )}^{2} - {0}^{2} {\vert}^{3} ] \leq D \qquad ( 8 )$$

$${l}_{1} \leq F ( {ξ}_{p} - {ε}_{1} ) \leq {u}_{1} \qquad ( 9 )$$

$${l}_{2} \leq F ( {ξ}_{p} + {ε}_{2} ) \leq {u}_{2} \qquad ( 10 )$$

The sample size evaluation unit 140 inputs the reliability 1−δ through the reliability input unit 120 (step S102). The reliability 1−δ corresponds to the probability (percentage) that a sufficient estimation of the true value by the estimate occurs.

The size determination unit 143 sets 2 as the initial value of the sample size n (step S103). The normal approximation unit 141 calculates a value (asymptotic approximation probability) Pₙ that approximates a probability, by asymptotic normality of the estimate distribution, that the value obtained by subtracting the estimate from the true value is less than or equal to the value of the left-side error and the value obtained by subtracting the true value from the estimate is less than or equal to the value of the right-side error (step S104). In other words, the normal approximation unit 141 performs the approximation process.

When the type of the calculated estimate is determined to be the sample average by the estimate type determination unit 100, in this example embodiment, the normal approximation unit 141 uses the following equation (11) as Pₙ in the process of step S104. Φ is the cumulative distribution function of the standard normal distribution.

$$\begin{matrix}[ Math . 3 ] & \\ {p}_{n} = Φ ( \frac{\sqrt{n} {ε}_{2}}{{σ}_{2}} ) - Φ ( - \frac{\sqrt{n} {ε}_{1}}{{σ}_{2}} ) & ( 11 )\end{matrix}$$

When the type of the calculated estimate is determined to be unbiased variance by the estimate type determination unit 100, in this example embodiment, the normal approximation unit 141 uses the following equation (12) as Pₙ in the process of step S104.

$$\begin{matrix}[ Math . 4 ] & \\ & ( 12 )\end{matrix}$$

$${P}_{n} = Φ ( \frac{n - 1}{n \sqrt{C}} \{ \{ \sqrt{n} {ε}_{2} \} + \frac{1}{\sqrt{n}} - \frac{\sqrt{n} {σ}_{2}^{2}}{n - 1} \} ) - Φ ( \frac{n - 1}{n \sqrt{C}} \{ - \{ \sqrt{n} {ε}_{1} \} + \frac{1}{\sqrt{n}} - \frac{\sqrt{n} {σ}_{1}^{2}}{n - 1} \} )$$

When the type of the calculated estimate is determined by the estimate type determination unit 100 to be the 100p % point of the sample, which is an example of a sample quantile, in this example embodiment, the normal approximation unit 141 uses the following equation (13) as Pₙ in the process of step S104. Equations (11) through (13) correspond to approximation formulas, respectively.

$$\begin{matrix}[ Math . 5 ] & \\ {P}_{n} = Φ ( \frac{n {l}_{2} - ⌊ np ⌋}{\sqrt{n {u}_{2} ( 1 - {l}_{2} )}} ) - Φ ( \frac{n {u}_{1} - ⌊ np ⌋}{\sqrt{n {u}_{1} ( 1 - {l}_{1} )}} ) & ( 13 )\end{matrix}$$

In equation (13), the value represented by the following symbol indicates the largest integer that does not exceed np.

$$\begin{matrix}[ Math . 6 ] & \\ ⌊ np ⌋ & \end{matrix}$$

The deviation evaluation unit 142 calculates the upper bound En (hereinafter, sometimes called “normal approximation error”) of absolute values for the difference (deviation) between the probability that the value obtained by subtracting the estimate from the true value is less than or equal to the value of the left-side error and the value obtained by subtracting the true value from the estimate is less than or equal to the value of the right-side error, and the value obtained by approximating the probability by the asymptotic normality of the estimate distribution (step S105). Eₙ corresponds to the deviation generated by the approximation process by the normal approximation unit 141. The process of calculating Eₙ is also called the deviation evaluation process.

When the type of the calculated estimate is determined to be a sample average by the estimate type determination unit 100, in this example embodiment, the deviation evaluation unit 142 uses the following equation (14) as Eₙ in the process of step S105.

$$\begin{matrix}[ Math . 7 ] & \\ {E}_{n} = \frac{2 {C}_{0} A}{{σ}_{1}^{3} \sqrt{n}} & ( 14 )\end{matrix}$$

When the type of the calculated estimate is determined to be unbiased variance by the estimate type determination unit 100, in this example embodiment, the deviation evaluation unit 142 uses the following equation (15) as Eₙ in the process of step S105.

$$\begin{matrix}[ Math . 8 ] & \\ {E}_{n} = 2 \{ \frac{3 {C}_{0} D}{\sqrt{n {B}^{3}}} + \frac{2 {C}_{0} A}{{σ}_{1}^{3} \sqrt{n}} + \frac{n - 1}{\sqrt{2 π {n}^{3} B}} + 2 Φ ( - \frac{1}{{σ}_{2}} \sqrt{n - 1} ) \} & ( 15 )\end{matrix}$$

When the type of the calculated estimate is determined to be 100p % points of the sample by the estimate type determination unit 100, in this example embodiment, the deviation evaluation unit 142 uses the following equation (16) as Eₙ in the process of step S105. Equations (14) to (16) correspond to the evaluation formulas (deviation evaluation formulas), respectively. In equations (14) to (16), C₀=0.4748.

$$\begin{matrix}[ Math . 9 ] & \\ {E}_{n} = {C}_{0} \{ \frac{{u}_{1}^{2} + {( 1 - {l}_{1} )}^{2}}{\sqrt{{nl}_{1} ( 1 - {u}_{1} )}} + \frac{{u}_{2}^{2} + {( 1 - {l}_{2} )}^{2}}{\sqrt{{nl}_{2} ( 1 - {u}_{2} )}} & ( 16 )\end{matrix}$$

The size determination unit 143 calculates the value of Pₙ−Eₙ (step S106). When Pₙ−Eₙ is less than the reliability 1−δ, the size determination unit 143 increases the sample size value by 1 and return to the state where the processing from step S104 onward is repeated (step S107). When Pₙ−Eₙ is greater than or equal to the reliability 1−δ, the size determination unit 143 determines the sample size n at that time as the sample size required to calculate the estimate for the determined type (step S108).

### [Description of Effect]

In this example embodiment, the sample size determination device can determine a sample size required to calculate the estimate without assuming normality in the distribution that the sample follows. Specifically, the sample size determination device can determine the sample size necessary for the probability that the value obtained by subtracting the estimate from the true value is less than or equal to the input left-side error and the value obtained by subtracting the true value from the estimate is less than or equal to the input right-side error is greater than or equal to the input reliability. The reason why it is not necessary to assume normality in the distribution that the sample follows is that through the processing by the normal approximation unit 141 and the deviation evaluation unit 142, the distribution of the estimate can be evaluated without using the properties inherent to the normal distribution.

### Example Embodiment 2

### [Description of Configuration]

Next, a reliability determination device as a second example embodiment of the information processing device will be described.

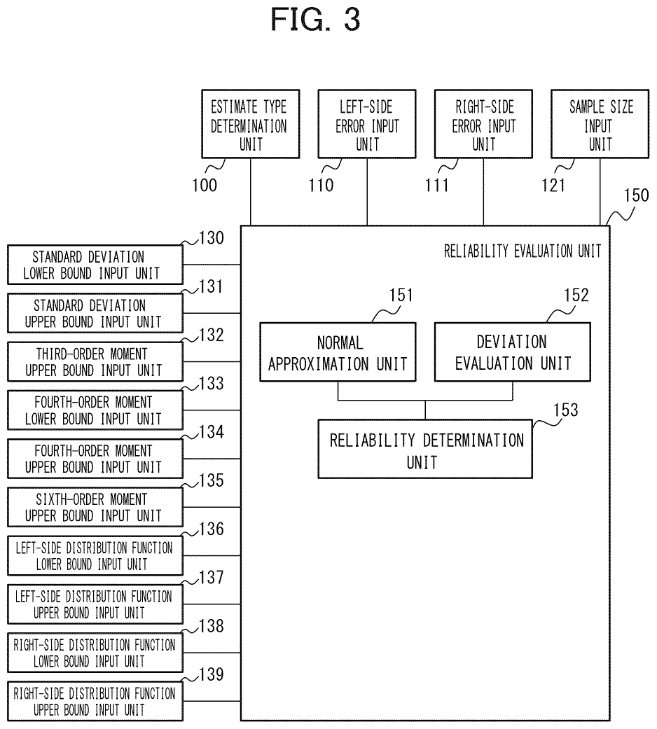

FIG. 3 is a block diagram showing a configuration example of a reliability determination device. As shown in FIG. 3, the reliability determination device of the second example embodiment comprises an estimate type determination unit 100, a left-side error input unit 110, a right-side error input unit 111, a sample size input unit 121, a standard deviation lower bound input unit 130, a standard deviation upper bound input unit 131, a third-order moment upper bound input unit 132, a fourth-order moment lower bound input unit 133, a fourth-order moment upper bound input unit 134, a sixth-order moment upper bound input unit 135, a left-side distribution function lower bound input unit 136, a left-side distribution function upper bound input unit 137, a right-side distribution function lower bound input unit 138, a right-side distribution function upper bound input unit 139, and a reliability evaluation unit 150.

The composition and functions of the estimate type determination unit 100, the left-side error input unit 110, the right-side error input unit 111, the standard deviation lower bound input unit 130, the standard deviation upper bound input unit 131, the third-order moment upper bound input unit 132, the fourth-order moment lower bound input unit 133, the fourth-order moment upper bound input unit 134, the sixth-order moment upper bound input unit 135, the left-side distribution function lower bound input unit 136, the left-side distribution function upper bound input unit 137, the right-side distribution function lower bound input unit 138, and the right-side distribution function upper bound input unit 139 have the same configurations and functions as those in the first example embodiment. The sample size input unit 121 inputs a sample size used to calculate an estimate.

The reliability evaluation unit 150 includes a normal approximation unit 151, a deviation evaluation unit 152, and a reliability determination unit 153.

Assuming the case where an estimate of the type input to the estimate type determination unit 100 is calculated, for the sample size input to the sample size input unit 121, the normal approximation unit 151 calculates a value (i.e., the asymptotic approximation probability) that approximates a probability that the value obtained by subtracting the estimate from the true value is less than the left-side error and the value obtained by subtracting the true value from the estimate is less than the right-side error. In other words, the normal approximation unit 151 approximates the estimate distribution by the normal distribution. In this example embodiment, the type of estimate is also a sample average, an unbiased variance, or a sample quantile.

The deviation evaluation unit 152 evaluates a deviation generated by the approximation process by the normal approximation unit 151. Specifically, assuming the case where an estimate of the type input to the estimate type determination unit 100 has been calculated, the deviation evaluation unit 152 calculates, for the sample size input to the sample size input unit 121, the upper bound of absolute values (i.e., normal approximation error) for the difference (i.e., deviation) between the probability that the value obtained by subtracting the estimate from the true value is less than or equal to the left-sided error and that the value obtained by subtracting the true value from the estimate is less than or equal to the right-sided error, and the value for which the probability is approximated by the asymptotic normality of the estimate distribution. The reliability determination unit 153 determines the value obtained by subtracting the value calculated by the deviation evaluation unit 152 from the value calculated by the normal approximation unit 151 as the reliability.

### [Description of Operation]

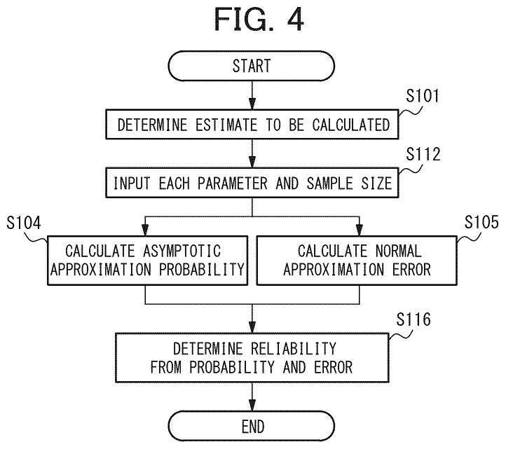

Next, the operation of the reliability determination device of this example embodiment will be explained with reference to the flowchart of FIG. 4.

First, the estimate type determination unit 100 determines the type of the input calculated estimate (step S101). The reliability evaluation unit 150 inputs each parameter similarly to the sample size evaluation unit 140 in the first example embodiment (refer to step S102 in FIG. 2) (step S112). However, in the first example embodiment, the sample size evaluation unit 140 received the reliability 1−δ through the reliability input unit 120, but in this example embodiment, the reliability evaluation unit 150 inputs the sample size through the sample size input unit 121 in the process of step S112,

The fact that each parameter satisfies the conditions of above equations (5) through (10) is the same as in the first example embodiment.

Similar to the normal approximation unit 141 in the first example embodiment, the normal approximation unit 151 calculates the asymptotic approximation probability Pₙ using one of the above equations (11), (12) and (13) according to the type of calculated estimate determined by the estimate type determination unit 100 (step S104). Similar to the deviation evaluation unit 142 in the first example embodiment, the deviation evaluation unit 152 calculates the normal approximation error Eₙ using one of the above equations (14), (15), and (16) according to the type of calculated estimate determined by the estimate type determination unit 100 (step S105). Unlike the normal approximation unit 141 and the deviation evaluation unit 142 in the first example embodiment, the normal approximation unit 151 and the deviation evaluation unit 152 in this example embodiment calculate the asymptotic approximation probability Pₙ and the normal approximation error Eₙ for the sample size input to the sample size input unit 121

The reliability determination unit 153 determines the value obtained by subtracting Eₙ calculated by the deviation evaluation unit 152 from Pₙ calculated by the normal approximation unit 151 as the reliability (step S116).

### Description of Effect

In this example embodiment, without assuming normality in the distribution that the sample follows, the reliability determination device can determine the lower bound of the probability that the value obtained by subtracting the estimate from the true value is less than or equal to the input left-side error and the value obtained by subtracting the true value from the estimate is less than or equal to the input right-side error, when the estimate is calculated from a sample of the input sample size. The reason why it is not necessary to assume normality in the distribution that the sample follows is that through the processing by the normal approximation unit 151 and the deviation evaluation unit 152, the distribution of the estimate can be evaluated without using the properties inherent to the normal distribution.

### Example Embodiment 3

### [Description of Configuration]

Next, the error determination device as a third example embodiment of information processing device is described.

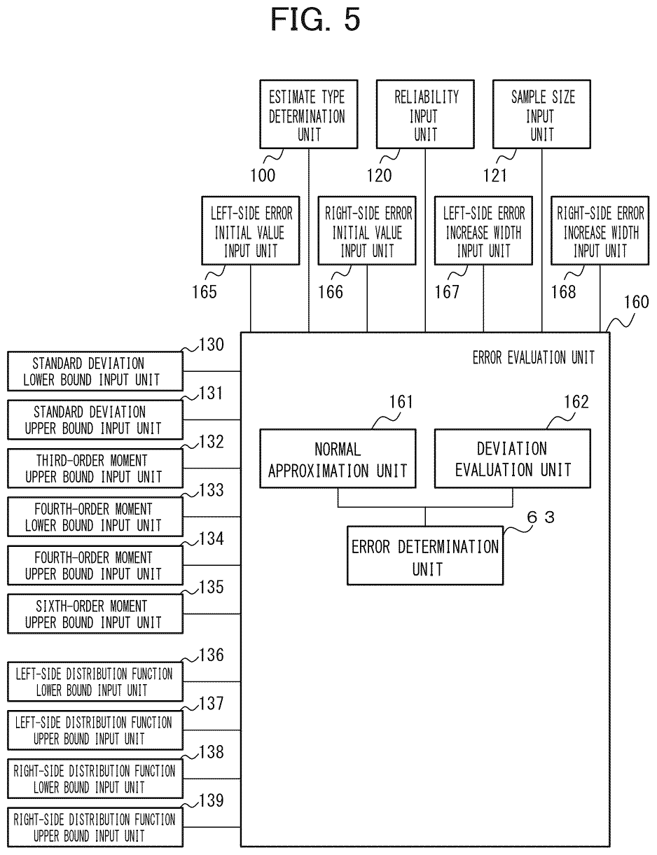

FIG. 5 is a block diagram showing a configuration example of an error determination device. As shown in FIG. 5, the error determination device of the third example embodiment comprises an estimate type determination unit 100, a reliability input unit 120, a sample size input unit 121, a standard deviation lower bound input unit 130, a standard deviation upper bound input unit 131, a third-order moment upper bound input unit 132, a fourth-order moment lower bound input unit 133, a fourth-order moment upper bound input unit 134, a sixth-order moment upper bound input unit 135, a left-side distribution function lower bound input unit 136, a left-side distribution function upper bound input unit 137, a right-side distribution function lower bound input unit 138, a right-side distribution function upper bound input unit 139, an error evaluation unit 160, the left-side error initial value input unit 165, a right-side error initial value input unit 166, a left-side error increase width input unit 167, and a right-side error increase width input unit 168.

The configurations and the functions of the estimate type determination unit 100, the reliability input unit 120, the sample size input unit 121, the standard deviation lower bound input unit 130, the standard deviation upper bound input unit 131, the third-order moment upper bound input unit 132, the fourth-order moment lower bound input unit 133, the fourth-order moment upper bound input unit 134, the sixth-order moment upper bound input unit 135, the left-side distribution function lower bound input unit 136, the left-side distribution function upper bound input unit 137, the right-side distribution function lower bound input unit 138, and the right-side distribution function upper bound input unit 139 are the same as those in the first or second example embodiment.

The left-side error initial value input unit 165 inputs the initial value of the left-side error, ε₁. The right-side error initial value input unit 166 inputs the initial value of the right-side error, ε₂. The left-side error increase width input unit 167 inputs a left-side error increase width η₁. The right-side error increase width input unit 168 inputs a right-side error increase width η₂. The left-side error corresponds to the error when the estimate is shifted to the left side of the true value. The right-side error corresponds to the error when the estimate is shifted to the right side of the true value.

The error evaluation unit 160 includes a normal approximation unit 161, a deviation evaluation unit 162, and an error determination unit 163.

Assuming the case where an estimate of the type input to the estimate type determination unit 100 has been calculated from the sample size sample input to the sample size input unit 121, the normal approximation unit 161 calculates, for the fixed left-side error and the fixed right-side error, a value (i.e., asymptotic approximation probability) that approximates, by asymptotic normality of estimate distribution, the probability that the value obtained by subtracting the estimate from the true value is less than or equal to the fixed left-side error and the value obtained by subtracting the true value from the estimate is less than or equal to the fixed right-side error. In other words, the normal approximation unit 161 approximates the estimate distribution by the normal distribution. In this example embodiment, the type of estimate is also a sample average, an unbiased variance, or a sample quantile, for example.

The deviation evaluation unit 162 evaluates a deviation generated by the approximation process by the normal approximation unit 161. Specifically, assuming the case where the estimate of the type input to the estimate type determination unit 100 has been calculated from the sample size sample input to the sample size input unit 121, for the fixed left-side error and the fixed right-side error, the deviation evaluation unit 162 calculates the upper bound of absolute values (i.e., normal approximation error) for the difference (i.e., deviation) between the probability that the value obtained by subtracting the estimate from the true value is less than or equal to a fixed left-side error and the value obtained by subtracting the true value from the estimate is less than or equal to a fixed right-side error, and the value obtained by approximating the probability by asymptotic normality of estimate distribution.

The error determination unit 163 increases the fixed value of the left-side error by η₁ and the fixed value of the right-side error by η₂ until the value calculated by the normal approximation unit 161 minus the value calculated by the deviation evaluation unit 162 is greater than or equal to a value input to the reliability input unit 120. The error determination unit 163 then determines the left-side error and the right-side error as the errors when the specified conditions are satisfied.

### [Description of Operation]

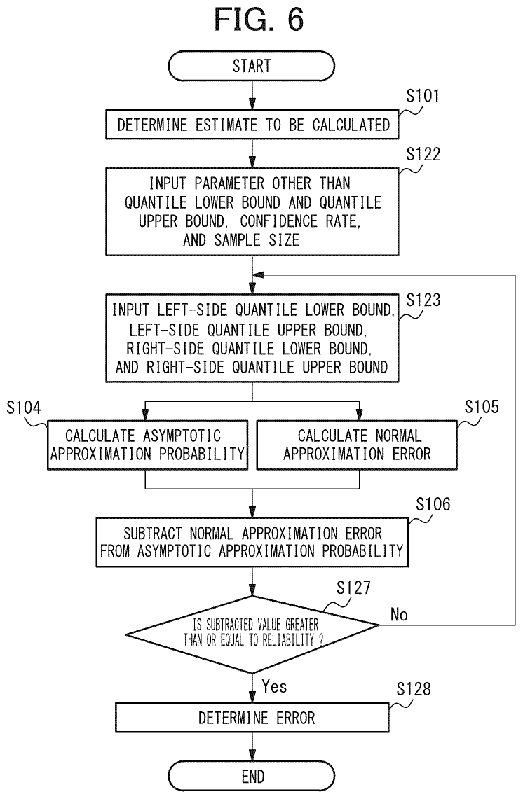

Next, the operation of the error determination device of this example embodiment will be explained with reference to the flowchart in FIG. 6.

First, the estimate type determination unit 100 determines the type of input calculated estimate (step S101).

The error evaluation unit 160 inputs each parameter (step S122). In this example embodiment, in the process of step S122, the error evaluation unit 160 inputs the initial values of the left-side error ε₁ and the initial value of the right-side error ε₂ through the left-side error initial value input unit 165 and the right-side error initial value input unit 166. The error evaluation unit 160 also inputs the standard deviation lower bound σ₁, the standard deviation upper bound σ₂, the third-order moment upper bound A, the fourth-order moment lower bound B, the fourth-order moment upper bound C and the sixth-order moment upper bound D through the standard deviation lower bound input unit 130, the standard deviation upper bound input unit 131, the third-order moment upper bound input unit 132, the fourth-order moment lower bound input unit 133, the fourth-order moment upper bound input unit 134, and the sixth-order moment upper bound input unit 135.

In addition, in the process of step S122, the error evaluation unit 160 inputs the left-side error initial value ε₁, the right-side error initial value ε₂, the left-side error increase width η₁, and the right-side error increase width η₂ through the left-side error initial value input unit 165, the right-side error initial value input unit 166, the left-side error increase width input unit 167, and the right-side error increase width input unit 168.

Each parameter satisfies the conditions of above equations (5) through (8).

While in the first example embodiment, the sample size evaluation unit 140 receives the reliability 1−δ through the reliability input unit 120, and in the second example embodiment, the reliability evaluation unit 150 receives the sample size through the sample size input unit 121, in this example embodiment the error evaluation unit 160 inputs both the reliability 1−δ and the sample size in step S122.

The error evaluation unit 160 inputs the left-side distribution function lower bound l₁, the left-side distribution function upper bound u₁, the right-side distribution function lower bound l₂, and the right-side distribution function upper bound u₂ through the left-side distribution function lower bound input unit 136, the left-side distribution function upper bound input unit 137, the right-side distribution function lower bound input unit 138, and the right-side distribution function upper bound input unit 139 (step S123).

The conditions of above equations (9) to (10) are satisfied with respect to each parameter input to the error evaluation unit 160 through the left-side distribution function lower bound input unit 136, the left-side distribution function upper bound input unit 137, the right-side distribution function lower bound input unit 138, and the right-side distribution function upper bound input unit 139.

Similar to the normal approximation unit 141 in the first example embodiment, the normal approximation unit 161 calculates the asymptotic approximation probability Pₙ using one of the above equations (11), (12) and (13) according to the type of calculated estimate determined by the estimate type determination unit 100 (step S104).

Similar to the deviation evaluation unit 142 in the first example embodiment, the deviation evaluation unit 162 calculates the normal approximation error Eₙ using one of the above equations (14), (15), and (16) according to the type of calculated estimate determined by the estimate type determination unit 100 (step S105).

The error determination unit 163 calculates the value of Pₙ−Eₙ (step S106). When Pₙ−Eₙ is less than the reliability 1−δ, the error determination unit 163 increases the left-side error ε₁ and the right-side error ε₂ by η₁ and η₂, respectively. When then returns to the state of repeating the process from step S123 onward (step S127). When Pₙ−Eₙ is greater than or equal to the reliability 1−δ, the error determination unit 163 determines the left-side error ε₁ and the right-side error ε₂ at that time as the error when the estimate of the determined type is calculated (step S128).

### Description of Effect

In this example embodiment, without assuming normality in the distribution that the sample follows, the error determination device can determine the left-side error and the right-side error so that the probability that the value obtained by subtracting the estimate from the true value is less than or equal to the left-side error and the value obtained by subtracting the true value from the estimate is less than or equal to the right-side error is greater than the reliability. The reason why it is not necessary to assume normality in the distribution that the sample follows is that through the processing by the normal approximation unit 161 and the deviation evaluation unit 162, the distribution of the estimate can be evaluated without using the properties inherent to the normal distribution.

### Example

Next, specific examples will be explained.

### First Example

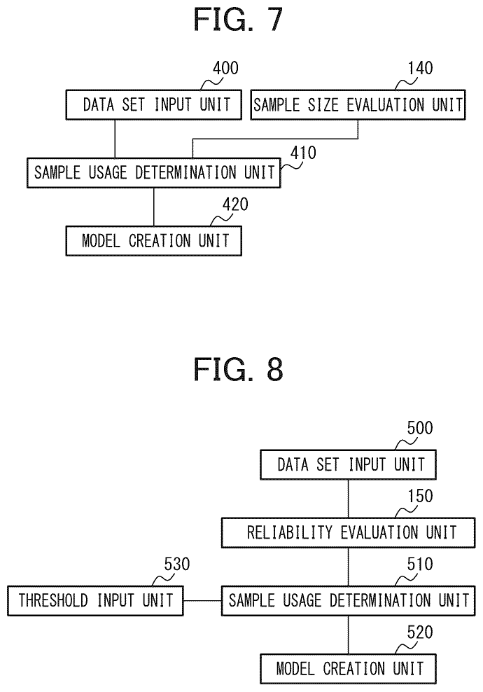

FIG. 7 is a block diagram showing first example. The first example is an example of the first example embodiment.

As shown in FIG. 7, the device of the first example comprises the sample size evaluation unit 140 in the first example embodiment, ae data set input unit 400, a sample usage determination unit 410, and a model creation unit 420.

The data set input unit 400 inputs a data set consisting of multiple samples that can have different sample sizes. The sample size evaluation unit 140 determines the sample size required to calculate a sample average, an unbiased variance or a sample quantile. The sample usage determination unit 410 extracts from the data set a number of samples that are greater than or equal to the sample size determined by the sample size evaluation unit 140.

The model creation unit 420 performs model creation by machine learning, using the sample average, the unbiased variance, or the sample quantile as a feature. In order to reduce scattering of the feature distribution and perform robust learning, the model creation unit 420 uses a data set consisting only of samples of sufficient size extracted by the sample usage determination unit 410 for training the model. Note that although this example has described the selection of data used to create a model, the results of the sample usage determination unit 410 can also be used to select test data for the constructed model.

### Second Example

FIG. 8 is a block diagram showing second example. The second example is an example of the second example embodiment.

As shown in FIG. 8, the device of the second example comprises a reliability evaluation unit 150 in the second example embodiment, a data set input unit 500, a sample usage determination unit 510, a model creation unit 520, and a threshold input unit 530.

The data set input unit 500 inputs a data set consisting of multiple samples that can have different sample sizes. The reliability evaluation unit 150 determines the reliability when a sample average, an unbiased variance, or a sample quantile is calculated from each sample in the data set. The sample usage determination unit 510 compares the reliability to the threshold input in the threshold input unit 530. The sample usage determination unit 510 extracts from the data set only those samples for which the reliability is greater than or equal to the threshold.

The model creation unit 520 performs model creation by machine learning, using the sample average, the unbiased variance, or the sample quantile as a feature. In order to reduce scattering of the feature distribution and perform robust learning, the model creation unit 520 uses a data set consisting only of samples from which feature extraction is possible with a sufficient reliability extracted by the sample usage determination unit 510 for training the model. Although this example describes the selection of data used to create the model, the results of the sample usage determination unit 510 can also be used to select test data for the constructed model.

### Third Example

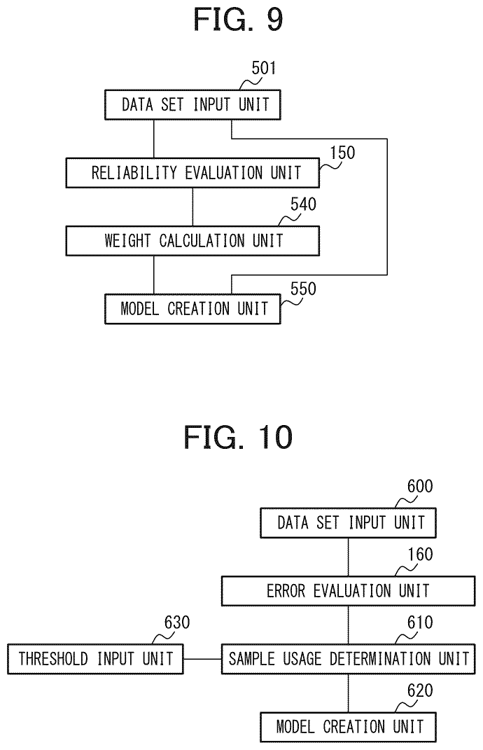

FIG. 9 is a block diagram showing third example. The third example is also an example of the second example embodiment.

As shown in FIG. 9, the device of the third example comprises the reliability evaluation unit 150 in the second example embodiment, a data set input unit 501, a weight calculation unit 540, and a model creation unit 550.

The data set input unit 501 inputs a data set consisting of multiple samples with a common sample size. The reliability evaluation unit 150 determines the reliability when the sample average, the unbiased variance or the sample quantile is calculated for the sample size common to each sample in the data set. The weight calculation unit 540 determines a weight to be assigned to each estimate according to the determined reliability. By assigning the weights determined by the weight calculation unit 540 to the sample average, the unbiased variance, or the sample quantile as a feature, the model creation unit 550 can create a model in which the features with high reliability are given importance. Although this example describes the selection of data used to create the model, the results of the weight calculation unit 540 can also be used when using test data for the constructed model.

### Fourth Example

FIG. 10 is a block diagram showing fourth example. The fourth example is an example of the third example embodiment.

As shown in FIG. 10, the device of the fourth example comprises the error evaluation unit 160 in the third example embodiment, a data set input unit 600, a sample usage determination unit 610, a model creation unit 620, and a threshold input unit 630.

The data set input unit 600 inputs a data set consisting of multiple samples that can have different sample sizes. The error evaluation unit 160 determines, for each sample in the data set, the error when the sample average, the unbiased variance or the sample quantile is calculated from that sample. The sample usage determination unit 610 compares the error to the threshold input into the threshold input unit 630. The sample usage determination unit 610 extracts from the data set only those samples for which the error is less than or equal to the threshold. The model creation unit 620 performs model creation by machine learning, using the sample average, the unbiased variance or the sample quantile as a feature. In order to reduce scattering of the feature distribution and perform robust learning, the model creation unit 620 uses for model training a data set consisting only of samples extracted by the sample usage determination unit 610 from which feature with sufficiently small errors from the true values can be extracted.

Although this example describes the selection of data used to create the model, the results of the sample usage determination unit 610 can also be used to select test data for the constructed model.

### Fifth Example

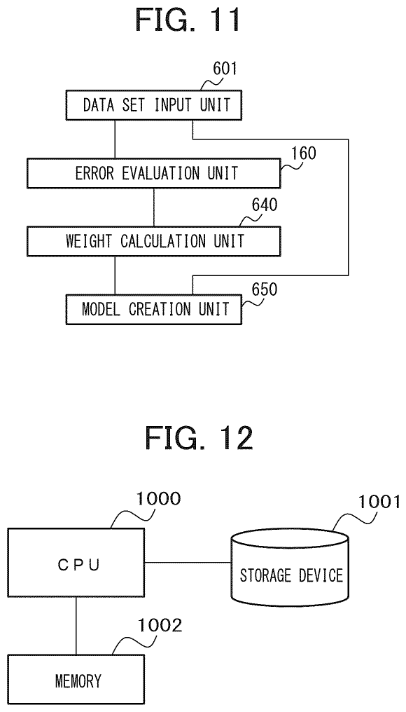

FIG. 11 is a block diagram showing fifth example. The fifth example is also an example of the third example embodiment.

As shown in FIG. 11, the device of the fifth example device comprises the error evaluation unit 160 in the third example embodiment, a data set input unit 601, a weight calculation unit 640, and a model creation unit 650.

The data set input unit 601 inputs a data set consisting of multiple samples with a common sample size. The error evaluation unit 160 determines an error when the sample average, the unbiased variance or the sample quantile is calculated for the sample size common to each sample in the data set. The weight calculation unit 640 determines a weight to be assigned to each estimate according to the smallness of the determined error. By assigning the weights determined by the weight calculation unit 640 to the sample average, the unbiased variance, or the sample quantile as a feature, the model creation unit 650 can create a model in which the feature with small errors from the true value are important. Although this example describes the selection of data used to create the model, the results of the weight calculation unit 640 can also be used when using test data for the built model.

The device of above example is applicable to applications such as improving a model by excluding samples with an insufficient sample size from the training data set in the construction of a model by machine learning that includes the sample average, the unbiased variance, or the sample quantile as a feature. The information processing device of the above example embodiment is applicable to applications such as knowledge in advance a sample size required for the calculation and using as a reference for the experimental design for data acquisition, when it is assumed that data analysis will be performed using either a sample average, an unbiased variance, or a sample quantile.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

Each function (each process) in the above example embodiments can be realized by a computer including a processor such as a CPU (Central Processing Unit) and memory. For example, a program for implementing the method (process) in the above example embodiment may be stored in a storage device (storage medium), and each function may be realized by executing the program stored in the storage device by a CPU.

FIG. 12 is a block diagram showing an example of a computer with a CPU. The computer is implemented in an image processing device. The CPU 1000 executes processing in accordance with a program stored in a storage device 1001 to realize the functions in the above example embodiments and examples. For example, the CPU 1000 can realize each function in each of the sample size determination device, the reliability determination device, and the error determination device shown in FIG. 1, FIG. 3 and FIG. 5. In other words, the CPU 1000 can realize the functions of the sample size evaluation unit 140 and each input unit shown in FIG. 1. In addition, the CPU 1000 can realize the functions of the reliability determination device and each input unit shown in FIG. 3. Further, the CPU 1000 can realize the functions of the error determination device and each input unit shown in FIG. 5.

The computer can also realize each function in the devices in each of the above examples. In other words, the CPU 1000 can realize the function of each block in the devices shown in FIG. 7 to FIG. 11.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a CD-ROM (Compact Disc-Read Only Memory), a CD-R (Compact Disc-Recordable), a CD-R/W (Compact Disc-ReWritable), and a semiconductor memory (for example, a mask ROM, a PROM (programmable ROM), an EPROM (erasable PROM), a flash ROM).

The program may be stored in various types of transitory computer readable media. The transitory computer readable medium is supplied with the program through, for example, a wired or wireless communication channel, i.e., through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

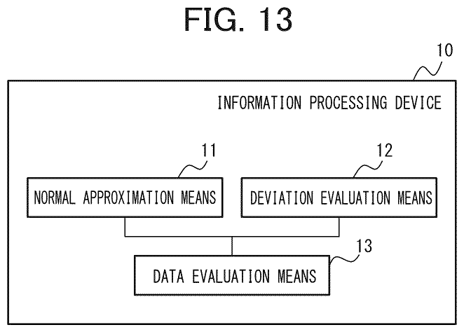

FIG. 13 is a block diagram showing the main part of the information processing device. The device 10 for calculating the estimate shown in FIG. 13 comprises normal approximation means (normal approximation unit) 11 (in the example embodiment, realized by the normal approximation units 141, 151, 161) for performing an approximation process to approximate estimate distribution with normal distribution, deviation evaluation means (deviation evaluation unit) 12 (in the example embodiment, realized by the deviation evaluation units 142, 152, and 162) for performing a deviation evaluation process that evaluates a deviation that occurs in the approximation process, and data evaluation means (data evaluation unit) 13 (in the example embodiment, realized by the size determination unit 143, the reliability determination unit 153, or the error determination unit 163) for evaluating data related to calculation of an estimate from a result of the approximation process and the deviation.

The data evaluation means 13 is, for example, sample size determination means (in the example embodiment, realized by the size determination unit 143) for determining a sample size for calculating the estimate as data related to the calculation of the estimate. The sample size is an example of data related to the calculation of the estimate. The sample size determination means sets the sample size when Pₙ−Eₙ is equal to or greater than the reliability 1−δ in an iterative operation for searching for the sample size (for example, the process of step S104 to S107 in the first example embodiment) to the finally determined sample size, for example.

The data evaluation means 13 is, for example, reliability determination means (in the example embodiment, realized by the reliability determination unit 153). The reliability is an example of data related to calculation of the estimate. In the second example embodiment, the reliability determination unit 153, which is an example of the reliability determination means, sets Pₙ−Eₙ to the reliability.

The data evaluation means 13 is, for example, error determination means (in the example embodiment, realized by the error determination unit 163) that determines an error between the estimate and true value. The error is an example of data related to calculation of the estimate.

A part of or all of the above example embodiments and examples may also be described as the following supplementary notes, but this invention is not limited to the following configurations.
(Supplementary note 1) An information processing device comprising:
normal approximation means for performing an approximation process to approximate estimate distribution with normal distribution;
deviation evaluation means for performing a deviation evaluation process that evaluates a deviation that occurs in the approximation process; and
data evaluation means for evaluating data related to calculation of an estimate from a result of the approximation process and the deviation.
(Supplementary note 2) The information processing device according to Supplementary note 1, wherein
the data evaluation means is sample size determination means for determining a sample size for calculating the estimate as data related to the calculation of the estimate.
(Supplementary note 3) The information processing device according to Supplementary note 2, wherein
the normal approximation means uses an approximation formula including the sample size as a parameter, and performs the approximation process while changing the parameter,
the deviation evaluation means uses an evaluation formula including the sample size as a parameter, and performs the deviation evaluation process while changing the parameter, and
the sample size determination means determines a value of the parameter as the sample size, when a difference between a result of the approximation process and the deviation is greater than or equal to reliability.
(Supplementary note 4) The information processing device according to Supplementary note 1, wherein
the data evaluation means is reliability determination means for determining the reliability as data related to the calculation of the estimate.
(Supplementary note 5) The information processing device according to Supplementary note 4, wherein
the normal approximation means performs the approximation process using an approximation formula that includes the sample size as a parameter,
the deviation evaluation means performs the deviation evaluation process using an evaluation formula that includes the sample size as a parameter, and
the reliability determination means determines a difference between a result of the approximation process and the deviation as reliability.
(Supplementary note 6) The information processing device according to Supplementary note 1, wherein
the data evaluation means is error determination means for determining an error between the estimate and a true value which is ta value to be estimated, as data related to the calculation of the estimate.
(Supplementary note 7) The information processing device according to Supplementary note 6, wherein
the normal approximation means performs the approximation process while changing a left-side error which corresponds to an error when the estimate is shifted to the left of the true value, and a right-side error which corresponds to an error when the estimate is shifted to the right of the true value,
the deviation evaluation means performs the deviation evaluation process while changing the left-side error and the right-side error, and
the error determination means determines the left-side error and the right-side error when a difference between a result of the approximation process and the deviation is greater than the reliability as an error between the estimate and the true value.
(Supplementary note 8) The information processing device according to any one of Supplementary notes 1 to 7, wherein
the estimate is a sample average, an unbiased variance, or a sample quantile.
(Supplementary note 9) An information processing method comprising:
performing a approximation process to approximate estimate distribution with normal distribution;
evaluating a deviation that occurs in the approximation process; and
evaluating data related to calculation of the estimate from a result of the approximation process and the deviation.
(Supplementary note 10) The information processing method according to Supplementary note 9, comprising:
determining a sample size for calculating estimate as data related to the calculation of the estimate.
(Supplementary note 11) The information processing method according to Supplementary note 9, comprising:
determining reliability as data related to the calculation of the estimate.
(Supplementary note 12) The information processing method according to Supplementary note 9, comprising:
determining an error between the estimate and a true value which is a value to be estimated, as data related to calculation of the estimate.
(Supplementary note 13) The information processing method according to any one of Supplementary notes 9 to 12, wherein
the estimate is a sample average, an unbiased variance, or a sample quantile.
(Supplementary note 14) A computer readable storage medium for storing an information processing program for causing a computer to execute:
performing a approximation process to approximate estimate distribution with normal distribution;
evaluating a deviation that occurs in the approximation process; and
evaluating data related to calculation of the estimate from a result of the approximation process and the deviation.
(Supplementary note 15) The information processing program according Supplementary note 14, causing the computer to execute
determining a sample size for calculating estimate as data related to the calculation of the estimate.

Although the invention of the present application has been described above with reference to example embodiments and examples, the present invention is not limited to the above example embodiments. Various changes can be made to the configuration and details of the present invention that can be understood by those skilled in the art within the scope of the present invention.

### REFERENCE SIGNS LIST

10 Information processing device
11 Normal approximation means
12 Deviation evaluation means
13 Data evaluation means
100 Estimate type determination unit
120 Confidence rate input unit
121 Sample size input unit
140 Sample size evaluation unit
141, 151, 161 Normal approximation unit
142, 152, 162 Deviation evaluation unit
143 Size determination unit
150 Confidence rate evaluation unit
153 Confidence rate determination unit
160 Error evaluation unit
163 Error determination unit
400 Data set input unit
410 Sample usage determination unit
420 Model creation unit
500, 501 Data set input unit
510 Sample usage determination unit
520, 550 Model creation unit
530 Threshold input unit
540 Weight calculation unit
600, 601 Data set input unit
610 Sample usage determination unit
620, 650 Model creation unit
630 Threshold input unit
640 Weight calculation unit
1000 CPU
1001 Storage device
1002 Memory

What is claimed is:

1. An information processing device comprising:
a memory storing software instructions; and
one or more processors configured to execute the software instructions to,
perform an approximation process to approximate estimate distribution with normal distribution;
perform a deviation evaluation process that evaluates a deviation that occurs in the approximation process; and
evaluate data related to calculation of an estimate from a result of the approximation process and the deviation.

2. The information processing device according to claim 1, wherein
the one or more processors are configured to execute to
determine a sample size for calculating the estimate as data related to the calculation of the estimate.

3. The information processing device according to claim 2, wherein
the one or more processors are configured to execute to
use an approximation formula including the sample size as a parameter, and performs the approximation process while changing the parameter,
use an evaluation formula including the sample size as a parameter, and performs the deviation evaluation process while changing the parameter, and
determine a value of the parameter as the sample size, when a difference between a result of the approximation process and the deviation is greater than or equal to reliability.

4. The information processing device according to claim 1, wherein
the one or more processors are configured to execute to
determine the reliability as data related to the calculation of the estimate.

5. The information processing device according to claim 4, wherein
the one or more processors are configured to execute to
perform the approximation process using an approximation formula that includes the sample size as a parameter,
perform the deviation evaluation process using an evaluation formula that includes the sample size as a parameter, and
determine a difference between a result of the approximation process and the deviation as reliability.

6. The information processing device according to claim 1, wherein
the one or more processors are configured to execute to
determine an error between the estimate and a true value which is ta value to be estimated, as data related to the calculation of the estimate.

7. The information processing device according to claim 6, wherein
the one or more processors are configured to execute to
perform the approximation process while changing a left-side error which corresponds to an error when the estimate is shifted to the left of the true value, and a right-side error which corresponds to an error when the estimate is shifted to the right of the true value,
the deviation evaluation process while changing the left-side error and the right-side error, and
determine the left-side error and the right-side error when a difference between a result of the approximation process and the deviation is greater than the reliability as an error between the estimate and the true value.

8. The information processing device according to claim 1, wherein
the estimate is a sample average, an unbiased variance, or a sample quantile.

9. An information processing method comprising:
performing a approximation process to approximate estimate distribution with normal distribution;
evaluating a deviation that occurs in the approximation process; and
evaluating data related to calculation of the estimate from a result of the approximation process and the deviation.

10. The information processing method according to claim 9, comprising:
determining a sample size for calculating estimate as data related to the calculation of the estimate.

11. The information processing method according to claim 9, comprising:
determining reliability as data related to the calculation of the estimate.

12. The information processing method according to claim 9, comprising:
determining an error between the estimate and a true value which is a value to be estimated, as data related to calculation of the estimate.

13. The information processing method according to claim 9, wherein
the estimate is a sample average, an unbiased variance, or a sample quantile.

14. A non-transitory computer readable recording medium storing an information processing program which, when executed by a processor, performs:
performing a approximation process to approximate estimate distribution with normal distribution;
evaluating a deviation that occurs in the approximation process; and
evaluating data related to calculation of the estimate from a result of the approximation process and the deviation.

15. The computer readable recording medium according claim 14, wherein when executed by the processor, the information processing program performs
determining a sample size for calculating estimate as data related to the calculation of the estimate.
